(19) United States
(12) Patent Application Publication
(10) Pub. No.: US 2009/0058711 A1
(43) Pub. Date: Mar. 5, 2009

(54) METHOD OF AND SYSTEM FOR MONITORING SECURITY OF CONTAINERS

(76) Inventors: Walter Vincent Dixon, Delanson, NY (US); Adam Kuenzi, Salem, OR (US); Wayne Floyd Larson, Salem, OR (US); Eric V. Sandberg, Knivsta (SE); Jeroen Te Paske, Weert (NL)

Correspondence Address: General Electric Company;GE Global Patent Operation, PO Box 861, 2 Corporate Drive, Suite 648, Shelton, CT, 06484, US

(21) Appl. No.: 11/847,760

(22) Filed: Aug. 30, 2007

(51) Int. Cl. G01S 13/56

(52) U.S. Cl. 342/28

(57) ABSTRACT

A system for monitoring the integrity of a container having at least one door. The system includes a data interpretation device disposed inside the container. The system further includes a radar sensor interoperably connected to the data interpretation device for monitoring internal conditions of the container and for providing radar data to the data interpretation device, a motion-detection sensor for monitoring motion inside the container, and an antenna interoperably connected to the data interpretation device for communicating information relative to the internal conditions of the container to a location outside the container.

### TECHNICAL FIELD

The present invention relates to a method of and system for monitoring the security of a container and, more particularly, but not by way of limitation, to a method of and system for monitoring the integrity of intermodal freight containers throughout a supply chain to discourage or prevent problems such as theft or adulteration of goods and other irregularities using a radar sensor and a container security device.

### HISTORY OF RELATED ART

The vast majority of goods shipped throughout the world are shipped via what are referred to as intermodal freight containers. As used herein, the term “containers” includes any container (whether with wheels attached or not), including, but not limited to, intermodal freight containers. The most common intermodal freight containers are known as International Organization for Standardization (ISO) general purpose general freight containers, meaning they meet certain specific dimensional, mechanical, and other standards issued by the ISO to facilitate global trade by encouraging development and use of compatible standardized containers, handling equipment, ocean-going vessels, railroad equipment and over-the-road equipment throughout the world for all modes of surface transportation of goods. Currently, there are approximately more than 16 million such containers in active circulation around the world. In addition, there are specialized containers, such as refrigerated containers that carry perishable commodities in active circulation around the world. However, the number of specialized containers is lower than the general purpose general freight containers. The United States alone receives approximately eleven million loaded containers per year, or approximately 17,000 per day, representing nearly half of the total value of all goods received each year. Since approximately 90% of all goods shipped internationally are moved in containers, container transport has become the backbone of the world economy.

The sheer volume of containers transported worldwide renders individual physical inspection impracticable, and only approximately 5% of containers entering the United States are actually physically inspected. Risk of introduction of a terrorist biological, radiological, or explosive device via a freight container is high, and the consequences to the international economy of such an event could be catastrophic, given the importance of containers in world commerce.

Even if sufficient resources were devoted in an effort to conduct physical inspections of all containers, such an undertaking would result in serious economic consequences. The time delay alone could, for example, cause the shut down of factories and undesirable and expensive delays in shipments of goods to customers.

Many current container designs fail to provide adequate mechanisms for establishing and monitoring the security of the containers or their contents. A typical container includes one or more door hasp mechanisms that allow for the insertion of a plastic or metal indicative “seal” or bolt barrier conventional “seal” to secure the doors of the container. The door hasp mechanisms that are conventionally used are very easy to defeat, for example, by drilling an attachment bolt of the hasp out of a door to which the hasp is attached. The conventional seals themselves currently in use are also quite simple to defeat by use of a common cutting tool and replacement with a rather easily duplicated seal.

A more advanced solution proposed in recent time is an electronic seal (“e-seal”). These e-seals are equivalent to traditional door seals and are applied to the containers. The e-seals include an electronic device such as a radio or radio reflective device that can transmit the e-seals serial number and a signal if the e-seal is cut or broken after it is installed. However, the e-seal is not able to communicate with the interior or contents of the container and does not transmit information related to the interior or contents of the container to another device. In general, e-seals are vulnerable to the same attacks as mechanical seals.

### SUMMARY OF THE INVENTION

A system for monitoring the integrity of a container having at least one door. The system includes a data interpretation device disposed inside the container. The system further includes a radar sensor interoperably connected to the data interpretation device for monitoring internal conditions of the container and for providing radar data to the data interpretation device, a motion-detection sensor for monitoring motion inside the container, and an antenna interoperably connected to the data interpretation device for communicating information relative to the internal conditions of the container to a location outside the container.

A method of monitoring the integrity of a container having at least one door. The method includes disposing inside the container a data interpretation device. The method further includes monitoring, via a radar sensor interoperably connected to the data interpretation device and a motion-detection sensor, internal conditions of the container and providing radar data to the data interpretation device. Furthermore, the method includes communicating, via an antenna interoperably connected to the data interpretation device, information relative to the internal conditions of the container to a location outside the container.

A system for monitoring the integrity of a container having at least one door. The system includes a data interpretation device disposed inside the container and a radar sensor interoperably connected to the data interpretation device for monitoring internal conditions of the container and for providing radar data to the data interpretation device, the data interpretation device and the radar sensor being mounted within a generally C-shaped channel of the container. The system further includes a motion-detection sensor interoperably connected to the data interpretation device and an antenna interoperably connected to the data interpretation device for communicating information relative to the internal conditions of the container and the motion inside the container to a location outside the container.

### BRIEF DESCRIPTION OF THE DRAWINGS

A more complete understanding of the present invention may be obtained by reference to the following Detailed Description of Illustrative Embodiments of the Invention, when taken in conjunction with the accompanying Drawings, wherein:

FIG. 1A is a diagram illustrating communication among components of a system;

FIG. 1B is a diagram illustrating a supply chain;

FIG. 2 is a schematic diagram of a device;

FIG. 3A is a first perspective cut-away view of a device;

FIG. 3B is a second perspective cut-away view of a device;

FIG. 4 illustrates a radar sensor;

FIG. 5A is a front view of the device and the radar sensor installed on an illustrative container;

FIG. 5B is a perspective view of the device and the radar sensor installed on an illustrative container; and

FIG. 6 is a flow diagram depicting illustrative steps for monitoring the integrity of containers.

### DETAILED DESCRIPTION OF ILLUSTRATIVE EMBODIMENTS OF THE INVENTION

Monitoring the integrity of containers via door movement can be relatively complex. Various systems have been developed for monitoring the integrity of containers. These systems include a sensor system having a sensor housing secured in a container in a position to monitor door position and a sensor secured in the sensor housing for detecting proximity of the door relative to another area of the container and for providing sensor data. The sensor system is typically installed between a right door and a right doorframe such that the sensor system is adapted to monitor and protect the right door of the container from tampering. An external keeper plate that prevents the opposite door from being opened dictates the choice of mounting location. However, in such cases, the left door of the container is susceptible to tampering when the existing sensor systems are used. Other sensor systems are vulnerable to hinge attacks or permit the container doors to be opened far enough to insert harmful objects.

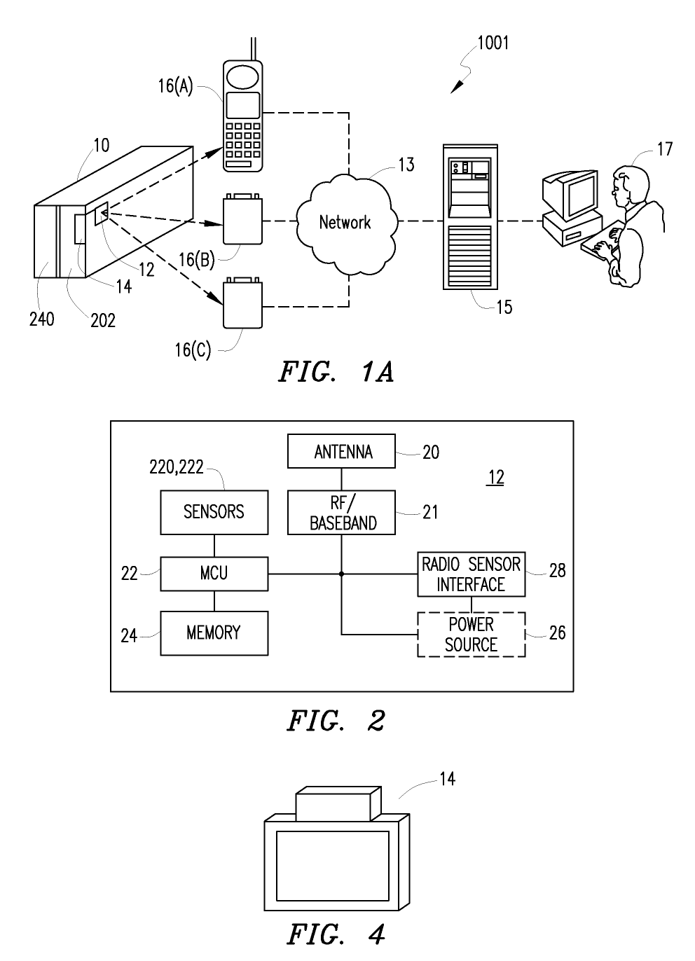

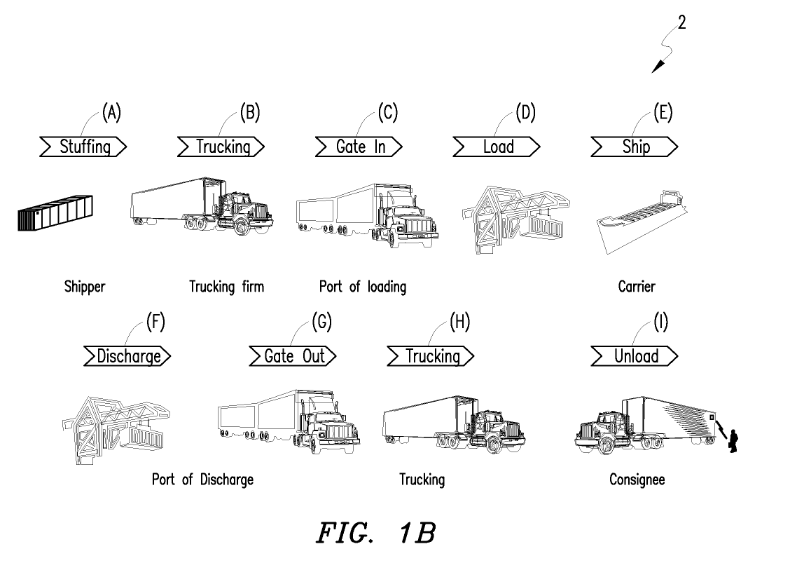

FIG. 1A is a diagram illustrating communication among components of a system 1001. The system 1001 includes a device 12, at least one radar sensor 14, at least one reader 16 (A)-(C), a server 15, and a software backbone 17. The device 12 and the radar sensor 14 serve to ensure that a container 10 has not been breached after the container 10 has been secured. The container 10 is monitored and tracked by the readers 16(A)-(C). Each of the readers 16(A)-(C) may include hardware or software for communicating with the server 15, such as a modem for transmitting data over GSM, CDMA, etc. or a cable for downloading data to a PC that transmits the data over the Internet to the server 15. Various conventional ways to transmit the data from the reader 16 to the server 15 may be implemented within the readers 16(A)-(C) or as a separate device. The readers 16(A)-(C) may be configured as a handheld reader 16(A), a mobile reader 16(B), or a fixed reader 16(C). The handheld reader 16(A) may be, for example, operated in conjunction with, for example, a mobile phone, a personal digital assistant, or a laptop computer. The mobile reader 16(B) is typically a fixed reader with a GPS interface, typically utilized in mobile installations (e.g., on trucks, trains, or ships using existing GPS, AIS, or similar positioning systems) to secure, track, and determine the integrity of the container in a manner similar to that of the hand-held reader 16(A). In fixed installations such as, for example, those of a port or shipping yard, the fixed reader 16(C) is typically installed on a crane or gate. The readers 16(A)-(C) serve primarily as relay stations between the device 12 and the server 15.

The server 15 stores a record of security transaction details such as, for example, door events (e.g., security breaches, container security checks, securing the container, and disarming the container), location, as well as any additional desired peripheral sensor information (e.g., temperature, motion, radioactivity). The server 15, in conjunction with the software backbone 17, may be accessible to authorized parties in order to determine a last known location of the container 10, make integrity inquiries for any number of containers, or perform other administrative activities.

The radar sensor 14 is interoperably connected to the device 12. The radar sensor 14 communicates with the device 12 via any suitable wired or wireless technology. The device 12 in turn communicates with the readers 16(A)-(C) via a short-range radio interface such as, for example, a radio interface utilizing direct-sequence spread-spectrum principles. The radio interface may use, for example, BLUETOOTH or any other short-range, low-power radio system that operates in the license-free Industrial, Scientific, and Medical (ISM) band, which operates around e.g. 2.4 GHz. Depending on the needs of a specific solution, different radio ranges may be provided. The device 12 may also communicate with readers 16(A)-(C) via a long range interface such as, for example, a long range wireless modem.

The readers 16(A)-(C) may securely communicate via a network 13, e.g. using TCP/IP, with the server 15 via any suitable technology such as, for example, Universal Mobile Telecommunications System (UMTS), Global System for Mobile Communications (GSM), Code Division Multiple Access (CDMA), Time Division Multiple Access (TDMA), Pacific Digital Cellular System (PDC), Wideband Local Area Network (WLAN), Local Area Network (LAN), Satellite Communications systems, Automatic Identification Systems (AIS), or Mobitex. The server 15 may communicate with the software backbone 17 via any suitable wired or wireless technology. The software backbone 17 is adapted to support real-time surveillance services such as, for example, tracking and securing of the container 10 via the server 15, the readers 16, and the device 12. The server 15 and/or the software backbone 17 are adapted to store information such as, for example, identification information, tracking information, door events, and other data transmitted by the device 12 and by any additional peripheral sensors such as, for example, the radar sensor 14 interoperably connected to the device 12. The software backbone 17 also allows access for authorized parties to the stored information via a user interface that may be accessed via, for example, the Internet.

Referring now to FIG. 1B, there is shown a diagram illustrating a flow 2 of an illustrative supply chain from points (A) to (I). Referring first to point (A), a container 10 is filled with cargo by a shipper or the like. At point (B), the container 10 is shipped to a port of embarkation via highway or rail transportation. At point (C), the container 10 is gated in at the port of loading such as a marine shipping yard.

At point (D), the container 10 is loaded on a ship operated by a carrier. At point (E), the container 10 is shipped by the carrier to a port of discharge. At point (F), the container 10 is discharged from the ship. Following discharge at point (F), the container 10 is loaded onto a truck and gated out of the port of discharge at point (G). At point (H), the container 10 is shipped via land to a desired location in a similar fashion to point (B). At point (I), upon arrival at the desired location, the container 10 is unloaded by a consignee.

As will be apparent to those having ordinary skill in the art, there are many times within the points of the flow 2 at which security of the container 10 could be compromised without visual or other conventional detection. In addition, the condition of the contents of the container could be completely unknown to any of the parties involved in the flow 2 until point (H) when the contents of the container are unloaded.

FIG. 2 is a block diagram of the device 12. The device 12 includes an antenna 20, an RF/baseband unit 21, a microprocessor (MCU) 22, a memory 24, and a plurality of sensors 220, 222. The device 12 may also includes an interface 28 for attachment of a sensor external to the device 12. In a preferred embodiment, the device 12 includes a plurality of sensors 220, 222; however, in another embodiment, the device 12 may not include any sensor. In various embodiments of the present invention, the external sensor may be, for example, the radar sensor 14. In a preferred embodiment, the device 12 and the radar sensor 14 have herein been listed as separate modules. However, in another embodiment, the device 12 and the radar sensor 14 may be separate functionalities within a single module. The radar sensor 14 is adapted to monitor various internal conditions of the container such as, for example, motion, door movements, and RF energy leakage. The device 12 may also optionally include a connector for interfacing directly with the readers 16(A)-(C). For example, a connector may be located on an outer wall of the container 10 for access by the readers 16(A)-(C). The readers 16(A)-(C) may then connect via a cable or other direct interface to download information from the device 12. The device 12 may also include an optional power source 26 (e.g., battery); however, other power arrangements that are detachable or remotely-located may also be utilized by the device 12. The presence of the power source 26 within the container 10 is advantageous in that the ability to tamper with or damage the power source 26 is decreased.

The microprocessor 22 discerns door events from the sensors 14, 220, 222, including, for example, container-security requests, container-disarming requests, and container-security checks. The discerned door events also include security breaches that may compromise the contents of the container 10, such as opening of a door after the container 10 has been secured. The door events may be time-stamped and stored in the memory 24 for transmission to the readers 16(A)-(C). The door events may be transmitted immediately, periodically, or in response to an interrogation from the readers 16(A)-(C).

The antenna 20 is provided for data exchange with the readers 16(A)-(C). In particular, various information, such as, for example, status and control data, may be exchanged. The microprocessor 22 may be programmed with a code that uniquely identifies the container 10. The code may be, for example, an International Organization for Standardization (ISO) container identification code. The microprocessor 22 may also store other logistic data, such as Bill-of-Lading (B/L), a mechanical seal number, a plurality of reader identifications with time- stamps, etc in local memory. A special log file may be generated, so that tracking history together with door events may be recovered. The code may also be transmitted from the device 12 to the readers 16(A)-(C) for identification purposes. The RF/baseband unit 21 upconverts microprocessor signals from baseband to RF for transmission to the readers 16(A)-(C).

The device 12 may, via the antenna 20, receive an integrity query from the reader 16. In response to the integrity query, the microprocessor 22 (MCU) may then access the memory to extract, for example, door events, temperature readings, security breaches, or other stored information in order to forward the extracted information to the readers 16(A)-(C). The readers 16(A)-(C) may also send a security or disarming request to the device 12. When the container 10 is secured by the readers 16(A)-(C), the MCU 22 of the device 12 may be programmed to emit an audible or visual alarm when the sensors 14, 220, 222 detect a change in magnetic flux density and a Doppler shift after the container is secured. The device 12 may also log the breach of security in the memory 24 for transmission to the readers 16(A)-(C). If the readers 16(A)-(C) send a disarming request to the device 12, the microprocessor 22 may be programmed to disengage from logging door events or receiving signals from the sensors 220, 222.

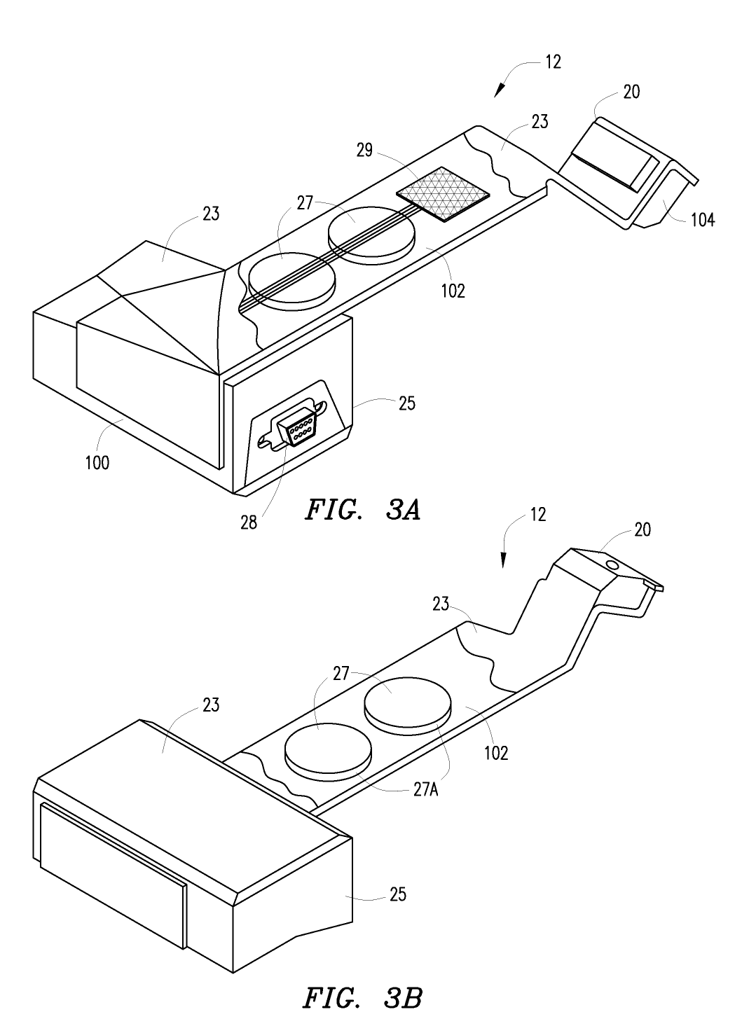

Referring now to FIG. 3A, there is shown a first perspective view of the device 12. The device 12 includes a housing 25 containing the data unit 100 (not explicitly shown), a support arm 102 extending therefrom, and an antenna arm 104 extending outwardly thereof in an angular relationship therewith. As will be described below, the size of the housing 25, the length of the support arm 102, and the configuration of the antenna 104 are carefully selected for compatibility with conventional containers. The housing 25, the support arm 102, and the antenna arm 104 are typically molded within a polyurethane material 23 or the like in order to provide protection from the environment. Still referring to FIG. 3A, a portion of material 23 of the support arm 102 is cut away to illustrate placement of at least one magnet 27 therein and at least one door sensor 29 thereon.

Referring now to FIG. 3B, there is shown a second perspective view of the device 12. FIG. 3B further illustrates the placement of the magnet 27 in the support arm 102. The magnet is positioned within corresponding apertures 27 A formed in the support arm 102 and are bonded to the apertures 27 A.

FIG. 4 illustrates the radar sensor 14. The radar sensor 14 is adapted to be installed within the container 10. In such embodiments, the container 10 is equipped with the radar sensor 14 for sensing security breaches that may compromise the contents of the container 10. The security breaches may include, for example, door opening, door movements, mechanical tampering with the container 10, and the like. The radar sensor 14 is adapted to produce low-power, wide-band, short duration pulses in the microwave frequency range. The pulses are transmitted from the radar sensor 14 into the interior region of the container 10 in order to flood the area inside the container 10 with radio frequency (RF) energy. More specifically, the area between the container doors 202 and 240 and the cargo inside the container 10 is typically flooded with RF energy. In a typical scenario, there is always a gap between the container doors 202, 240 and the cargo in order to prevent the cargo from resting directly on the container doors 202, 240 thereby creating a dangerous situation for a person opening the container doors 202, 240. It is therefore a common practice to use shoring to hold back the cargo from touching the container doors 202, 240.

When either one of the container doors 202, 240 is opened, for example, to insert or remove an article, or in the event of door movement, RF energy from the radar mounted in proximity to the container doors 202, 240 reflects off the container doors 202, 240 and undergoes a slight frequency shift. As the gap between the container doors 202, 240 increase, RF energy escapes and the average energy as measured by the radar changes.

Additionally, when either one of the container doors 202, 240 is opened more than a pre-defined distance (e.g., 2 inches), for example, to insert or remove an article, the RF energy near the container doors 202, 240 exits the container 10 and reflections from outside the container 10 causes a frequency shift causing a Doppler shift inside the container 10. In an exemplary embodiment, if either one of the container doors 202, 240 is opened to exceed a predetermined door opening threshold, reflections from outside the container 10 may cause a shift inside the container 10. Average energy measurements may also be used to detect a door opening.

In various embodiments, the radar sensor 14 is oriented within the container 10 such that the radar sensor 14 is disposed within a generally C-shaped recess or channel of the container 10. In another embodiment, the radar sensor 14 is oriented within the container 10 so that the radar sensor 14 is mounted on a ceiling of the container 10 near the doors 202, 240 of the container 10. In such embodiments, a Micro-Impulse Radar (MIR) is utilized as the radar sensor 14. The MIR employs a pulse transmitter (not explicitly shown) that emits 10 nsec, 5.8 GHz microwave transmit pulses at a pulse repetition frequency (“PRF”) in a range from 50 to 500 kHz (preferably 400 KHz) in response to a PRF generator (not explicitly shown) and a 10-nsec monostable multi-vibrator (not explicitly shown).

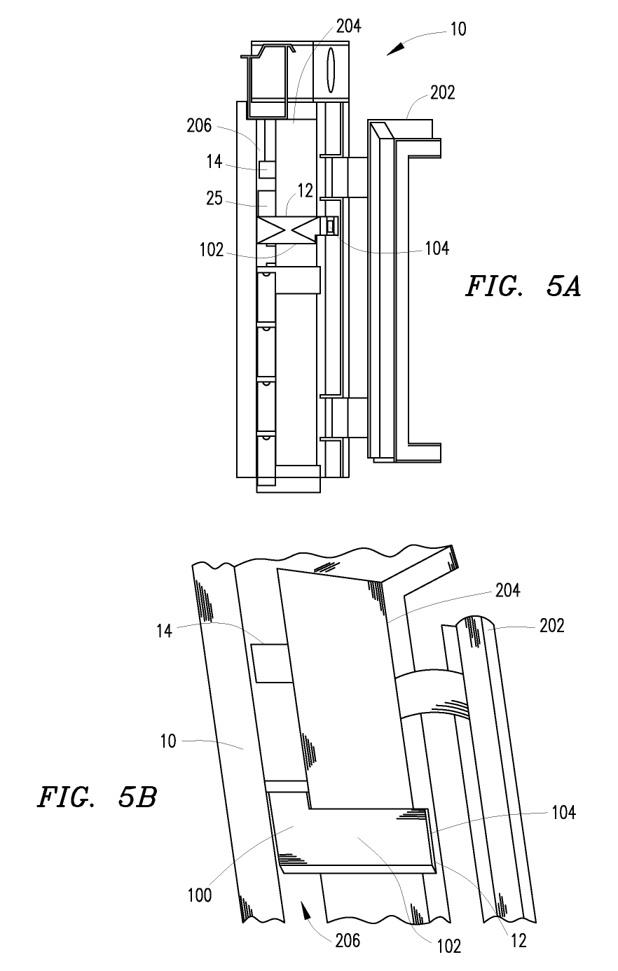

FIG. 5A illustrates a front view of the device 12 and the radar sensor 14 as installed on the container 10. The container 10 is shown with a door 202 of the container 10 in an open position to show the orientation of the device 12 and the radar sensor 14 in greater detail. The device 12 and the radar sensor 14 are mounted to an area adjacent to the door 202 of the container 10. The device 12 and the radar sensor 14 may be mounted via a magnetic connection, an adhesive connection, or any other suitable connection, for example, on a vertical beam 204 of the container 10. As can be seen in FIG. 5A, the device 12 is mounted so that, when the door 202 is closed, the antenna arm 104 is located on the exterior of the container 10 and the data unit 100 is located on the interior of the container 10. It should be noted that the mounting of the device 12 and the radar sensor 14 on the container 10 as shown in FIG. 5A is illustrative.

The device 12 is typically oriented within the container 10 so that the data unit 100 is disposed within a generally C-shaped recess or channel 206. The radar sensor 14 is also typically oriented within the container 10 such that it is disposed within the generally C-shaped recess or channel 206.

The device 12 may transmit data relative to the status of the door 202 via the antenna 20 to the server 15 as described above. In an exemplary embodiment, the interface 28 (FIG. 2) is connected to the radar sensor 14 in order to capture information relative to internal conditions of the container 10 and the information obtained via the radar sensor 14 transmitted to the server 15.

FIG. 5B is a perspective view of the device 12 and the radar sensor 14 as installed on the container 10. The device 12 is shown attached to the vertical beam 204 so that the antenna arm 104 is positioned in an area of a hinge channel of the container 10. The data unit 100 and the radar sensor 14 are each positioned inside the C-channel 206 of the container 10. As more clearly shown herein, the antenna arm 104 protrudes from the support arm 102 to an area substantially near the hinge portion of the container 10 in order to remain on the exterior of the container 10 when the door 202 is closed.

With reference to FIGS. 1A-5B, illustrative use of the radar sensor 14 in combination with the device 12 will now be described. In a typical embodiment, the device 12 and the radar sensor 14 are mounted to an area adjacent to the door 202 of the container 10. More specifically, the device 12 and the radar sensor 14 are disposed within the generally C-shaped channel 206. The radar sensor 14 is utilized for sensing a security breach that may compromise the contents of the container 10. The radar sensor 14 is adapted to produce low-power, wide-band, short duration pulses in the microwave frequency range. The pulses are transmitted from the radar sensor 14 into the interior region of the container 10.

Since the container 10 is generally constructed of metal, the pulses are reflected off the interior surface of the container 10. The radar sensor 14 typically includes a time of flight range gate that enables measurements of reflected microwave signals during a time gate period. The time gate period refers to an approximate time required for a microwave pulse to propagate a maximum distance within the container 10 and reflect back to the radar sensor 14.

In various embodiments, two measurements are made from the reflected microwave signals. First a direct current (DC) signal level is produced that represents an average reflected signal level within the container 10. Regarding the DC signal level, if any opening is created in the container 10, or an opening of the container doors 202, 240, the DC signal level with the radar sensor 14 shifts as the average reflected signal changes as a function of a signal pattern change. The larger the opening, the larger the DC signal level shift. Second, a Doppler shift measurement is made that represents motion inside the container 10. The motion inside the container may represent, for example, container door opening, human movement, cargo shifting and the like. Any such motion creates a Doppler shift signal that is detectable by the radar sensor 14.

In various embodiments, the radar sensor 14 is continuously activated to detect security breaches of the container 10 by measuring the DC shift signal and the Doppler shift signal inside the container 10. The security breaches may be the result of container door opening, human movement, cargo shifting, and the like. In order to avoid false alarms due to, for example, cargo shifting, a motion-detection sensor 220, 222 is placed within the device 12 to detect motion inside the container 10 due to cargo shifting. According to an alternate embodiment, the motion-detection sensor 220, 222 is integrated within the radar sensor 14. According to an exemplary embodiment, the motion-detection sensor 220, 222 may be, for example, an accelerometer. The motion-detection sensor 220, 222 is adapted to provide a motion-detection measurement that corresponds to motion within the container 10 due to, for example, cargo shifting.

If the DC shift signal and/or the Doppler shift signal exceeds a predetermined threshold and the motion-detection measurement exceeds a predetermined motion-detection measurement threshold, it is determined that no security breach of the container 10 has occurred. Any motion within the container 10 that creates a DC shift signal and a Doppler shift signal that exceeds a predetermined threshold level and a motion-detection measurement does not exceed a predetermined motion-detection measurement threshold is an indication that a container security breach has occurred. The security breach may be caused by, for example, a DC shift signal and a Doppler shift signal due to door opening of 2 inches or greater or mechanical tampering with the container 10. Mechanical tampering of the container 10 may include, for example, opening container doors 202, 240 without permission, creating holes in the container 10, and the like. Such a DC shift signal and a Doppler shift signal will be utilized as an input signal to the radar interface 28 of the device 12. The device 12 in turn communicates with the readers 16(A)-(C) via a short-range radio interface such as, for example, a radio interface utilizing direct-sequence spread-spectrum principles. The readers 16(A)-(C) serve primarily as relay stations between the device 12 and the server 15. The server 15 stores a record of security transaction details such as, for example, door events (e.g., security breaches, container security checks, securing the container, and disarming the container), location, as well as any additional desired peripheral sensor information (e.g., temperature, motion, radioactivity). The server 15, in conjunction with the software backbone 17, may be accessible to authorized parties in order to determine a last known location of the container 10, make integrity inquiries for any number of containers, or perform other administrative activities such as, for example, activating a security alarm.

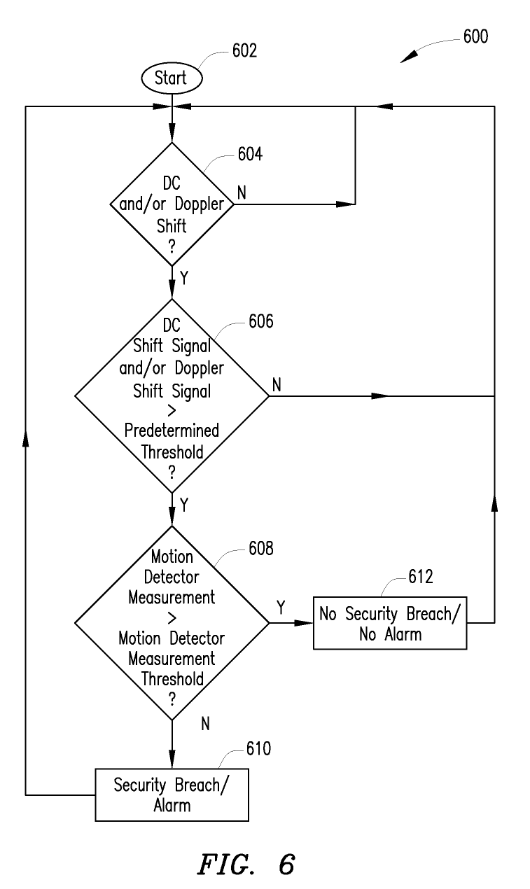

FIG. 6 is a flow diagram illustrating an exemplary process 600 for monitoring the integrity of a container in accordance with principles of the invention. The process 600 starts at step 602. At step 604, it is determined whether a DC shift signal and/or a Doppler shift has been detected. If it is determined at step 604 that a DC shift signal and/or a Doppler shift has been detected, the process 600 proceeds to step 606. However, if it is determined at step 604 that a DC shift signal and/or a Doppler shift has not been detected, the process 600 returns to step 604.

At step 606, it is determined if the DC shift signal and/or the Doppler shift signal exceeds a predetermined threshold. If it is determined at step 606 that the DC shift signal and the Doppler shift signal does not exceed the predetermined threshold, the process 600 returns to step 604. However, if it is determined at step 606 that the DC shift signal and the Doppler shift signal exceeds the predetermined threshold, the process 600 proceeds to step 608.

At step 608, it is determined if the motion detector measurement exceeds a motion-detection measurement threshold. If it is determined at step 608 that the motion detection measurement does not exceed the motion-detection measurement threshold, a security alarm is activated at step 610. From step 610, the process 600 returns to step 604. However, if it is determined at step 608 that the motion-detection measurement exceeds the motion-detection measurement threshold, the process 600 proceeds to step 612, at which step a security alarm remains deactivated and the process 600 returns to step 604.

The previous Detailed Description is of embodiment(s) of the invention. The scope of the invention should not necessarily be limited by this Description. The scope of the invention is instead defined by the following claims and the equivalents thereof.

What is claimed is:

1. A system for monitoring the integrity of a container having at least one door, the system comprising:
a data interpretation device disposed inside the container;
a radar sensor interoperably connected to the data interpretation device for monitoring internal conditions of the container and for providing radar data to the data interpretation device;
a motion-detection sensor for monitoring motion inside the container; and
an antenna interoperably connected to the data interpretation device for communicating information relative to the internal conditions of the container to a location outside the container.

2. The system of claim 1, wherein the data interpretation device and the radar sensor are mounted to an area adjacent to the at least one door of the container.

3. The system of claim 1, wherein the data interpretation device and the radar sensor are mounted within a generally C-shaped channel of the container.

4. The system of claim 1, wherein the radar sensor is a Micro Impulse Radar.

5. The system of claim 4, wherein the radar sensor is adapted to transmit low-power, wide-band, short duration pulses in the microwave frequency range into an interior region of the container.

6. The system of claim 5, wherein the radar sensor is adapted to detect security breach of the container by detecting a direct current (DC) shift signal and/or a Doppler shift signal inside the container.

7. The system of claim 6, wherein any of a container door movement, human movement, tampering with the container, and cargo shifting results in generation of the direct current (DC) shift signal and the Doppler shift signal.

8. The system of claim 1, wherein the motion-detection sensor is adapted to monitor motion inside the container due to cargo shifting.

9. The system of claim 1, wherein the motion-detection sensor is integrated within the data interpretation device.

10. The system of claim 1, wherein the motion-detection sensor is integrated within the radar sensor.

11. The system of claim 1, wherein the motion-detection sensor is an accelerometer.

12. The system of claim 1, wherein the radar sensor is mounted on a ceiling of the container near the at least one door.

13. The system of claim 1, wherein the data interpretation device includes an interface for receiving the radar data.

14. The system of claim 1, wherein the data interpretation device comprises at least one sensor.

15. A method of monitoring the integrity of a container having at least one door, the method comprising:
disposing inside the container a data interpretation device;
monitoring, via a radar sensor interoperably connected to the data interpretation device and a motion-detection sensor, internal conditions of the container;
providing radar data to the data interpretation device; and
communicating, via an antenna interoperably connected to the data interpretation device, information relative to the internal conditions of the container to a location outside the container.

16. The method according to claim 15, comprising the step of mounting the data interpretation device and the radar sensor to an area adjacent to the at least one door of the container.

17. The method according to claim 15, comprising the step of mounting the data interpretation device and the radar sensor within a generally C-shaped channel of the container.

18. The method according to claim 15, wherein the radar sensor is a Micro Impulse Radar.

19. The method according to claim 18, further comprising the step of transmitting, via the radar sensor, low-power, wide-band, short duration pulses in the microwave frequency range into an interior region of the container.

20. The method according to claim 15, further comprising the steps of:
detecting, via the radar sensor, security breach of the container by detecting a direct current (DC) shift signal and a Doppler shift signal inside the container; and
detecting, via the motion-detection sensor, motion inside the container due to cargo shifting.

21. The method according to claim 20, further comprising the step of activating a security alarm if the direct current (DC) shift signal and/or the Doppler shift signal exceeds a predetermined threshold and a motion-detection measurement does not exceed a motion-detection measurement threshold.

22. The method according to claim 15, wherein the motion-detection sensor is integrated within the data interpretation device.

23. The method according to claim 15, wherein the motion-detection sensor is integrated within the radar sensor.

24. The method of claim 15, further comprising the step of mounting the radar sensor on a ceiling of the container near the at least one door.

25. The method of claim 15, further comprising the step of detecting, via the radar sensor, security breach of the container by detecting a direct current (DC) shift signal and a Doppler shift signal inside the container when the at least one door of the container is opened to exceed a predetermined door opening threshold.

26. The method of claim 15, wherein the data interpretation device comprises at least one sensor.

27. A system for monitoring the integrity of a container having at least one door, the system comprising:
a data interpretation device disposed inside the container;
a radar sensor interoperably connected to the data interpretation device for monitoring internal conditions of the container and for providing radar data to the data interpretation device, the data interpretation device and the radar sensor being mounted within a generally C-shaped channel of the container;
a motion-detection sensor interoperably connected to the data interpretation device; and
an antenna interoperably connected to the data interpretation device for communicating information relative to the internal conditions of the container and the motion inside the container to a location outside the container.
